(19) United States
(12) Patent Application Publication
(10) Pub. No.: US 2024/0275065 A1
(43) Pub. Date: Aug. 15, 2024

(54) ANTENNA AND COMMUNICATION DEVICE

(71) Applicant: HUAWEI TECHNOLOGIES CO., LTD., Shenzhen (CN)

(72) Inventors: Xingwei Xiao, Shenzhen (CN); Chengdai Xue, Dongguan (CN); Zijing Du, Xi’an (CN); Dingjiu Daojian, Dongguan (CN)

(21) Appl. No.: 18/642,388

(22) Filed: Apr. 22, 2024

Related U.S. Application Data
(63) Continuation of application No. PCT/CN2022/121391, filed on Sep. 26, 2022.

(30) Foreign Application Priority Data
Oct. 22, 2021 (CN) 202111238180.3

(51) Int. Cl. H01Q 15/04; H01Q 1/24; H01Q 1/48; H01Q 1/52; H01Q 15/14; H01Q 21/06; H01Q 21/24

(52) U.S. Cl. CPC H01Q 15/04; H01Q 1/48; H01Q 1/52; H01Q 15/14; H01Q 21/062; H01Q 1/246; H01Q 21/24

(57) ABSTRACT

This application provides an antenna and a communication device, and relates to the field of communication technologies, to resolve a problem that the antenna cannot effectively balance a narrow beam width and a small height of a cross section. In the antenna provided in this application, the beam width of the first radiating element can be effectively narrowed by configuring the first conductive part, and the height of the cross section of the antenna is not significantly increased.

### CROSS-REFERENCE TO RELATED APPLICATIONS

This application is a continuation of International Application No. PCT/CN2022/121391, filed on Sep. 26, 2022, which claims priority to Chinese Patent Application No. 202111238180.3, filed on Oct. 22, 2021. The disclosures of the aforementioned applications are hereby incorporated by reference in their entireties.

### TECHNICAL FIELD

This application relates to the field of communication technologies, and in particular, to an antenna and a communication device.

### BACKGROUND

Antennas are widely used in a plurality of different types of communication devices, and are configured to implement sending or receiving of radio signals. During actual application, improving antenna performance is a major goal in the industry. The antenna performance is mainly reflected by the following parameters: a gain, a standing wave ratio, a return loss, a communication capacity, a beam width, and the like.

Currently, in some antennas, a structure such as a director is configured in the antenna to increase a gain of the antenna. However, this manner increases a size of a cross section of the antenna, and is not conducive to a miniaturization design of the antenna.

### SUMMARY

This application provides a communication device and an antenna that can narrow a beam width and increase a gain. In addition, the antenna has a simple structure, is easy to be manufactured, and is conducive to a miniaturization design.

According to an aspect, this application provides an antenna, including a first radiating element and a first conductive part. The first radiating element is configured to transmit or receive a radio signal, and the first conductive part and the first radiating element are connected to a common ground. 2N first conductive parts are correspondingly disposed in one polarization direction of the radiating element, and N is a positive integer. A distance between the first conductive part and a center of the first radiating element is L1, a maximum distance from an edge of the first radiating element to the feeding center is L2, and L1≤L2. The first conductive part is coupled to the first radiating element, so that a beam width of the first radiating element can be narrowed. Alternatively, it may be understood that, an integer multiple of 2 first conductive parts may be disposed in each polarization direction of the first radiating element. In the antenna provided in this application, the beam width of the first radiating element can be effectively narrowed by configuring the first conductive part, and a height of a cross section of the antenna is not significantly increased. In addition, the first conductive part has a simple structure, and is easy to be processed. This is conducive to low-cost implementation, and is conducive to manufacturing and wide application.

When the first conductive part is specifically disposed, a specific value of the distance L1 between the first conductive part and the center of the first radiating element may be properly set based on an actual situation.

For example, L1 may be less than or equal to 0.1 times an operating wavelength of the first radiating element. The distance between the first conductive part and the center of the first radiating element is properly adjusted, so that a coupling effect between the first conductive part and the first radiating element can be effectively improved, thereby effectively narrowing the beam width of the first radiating element and increasing a gain of the first radiating element.

In addition, when the first conductive part is disposed, a length of the first conductive part may also be properly adjusted based on an actual requirement.

For example, the length of the first conductive part may be greater than or equal to 0.25 times the operating wavelength of the first radiating element.

In addition, it is found, by considering impact of a standing wave and by comparing massive experiments and data, that if the length of the first conductive part is slightly greater than 0.25 times the operating wavelength of the first radiating element, the first conductive part can be better coupled to the first radiating element, to significantly narrow the beam width of the first radiating element. During specific implementation, the length of the first conductive part may be 0.26 times, 0.27 times, 0.28 times, or the like the operating wavelength of the first radiating element. This is not specifically limited in this application.

During specific application, the antenna may further include a second radiating element. An operating frequency of the first radiating element may be greater than an operating frequency of the second radiating element. Alternatively, it may be understood that, a plurality of radiating elements with different operating frequencies are configured in the antenna, so that a bandwidth of the antenna can be effectively increased.

In addition, in some implementations, the antenna may further include a second conductive part, and the second conductive part and the second radiating element may be connected to a common ground. 2M second conductive parts are correspondingly disposed in one polarization direction of the second radiating element, and M is a positive integer. A distance between the second conductive part and a center of the second radiating element is L3, a maximum distance from an edge of the second radiating element to the center of the second radiating element is L4, and L3<L4. The second conductive part is coupled to the second radiating element, so that a beam width of the second radiating element can be narrowed. Alternatively, it may be understood that, an integer multiple of 2 second conductive parts may be disposed in each polarization direction of the second radiating element. In the antenna provided in this application, the beam width of the second radiating element can be effectively narrowed by configuring the second conductive part, and a height of a cross section of the antenna is not significantly increased. In addition, the second conductive part has a simple structure, and is easy to be processed. This is conducive to low-cost implementation, and is conducive to manufacturing and wide application.

When the second conductive part is specifically disposed, a specific value of the distance L3 between the second conductive part and the center of the second radiating element may be properly set based on an actual situation.

For example, L3 may be less than or equal to 0.1 times an operating wavelength of the second radiating element.

It may be understood that, when the second conductive part is specifically disposed, a same or similar setting may be performed based on the foregoing situation of the first conductive part, and details are not described herein again.

In an implementation, the second conductive part may include a filtering structure. The filtering structure is configured to filter the radio signal of the first radiating element, to reduce interference caused by the second conductive part to the radio signal of the first radiating element. The filtering structure is disposed in the second conductive part, so that an induced current generated in the second conductive part by a radio signal, with a high frequency, generated by the first radiating element can be suppressed, thereby improving signal transmission efficiency and transmission quality of the first radiating element.

During specific implementation, there may be various specific structures of the filtering structure. For example, the filtering structure may include at least one of a wide-narrow connection structure, a fork structure, or a bent structure. Alternatively, in another implementation, the filtering structure may use another structure form. This is not limited in this application.

In addition, in some implementations, the antenna may further include a third conductive part. The third conductive part and a radiating element operating in a high frequency may be connected to a common ground, and is configured to suppress common-mode resonance generated by a radio signal with a high frequency in a radiating element operating in a low frequency.

Specifically, in an implementation provided in this application, the operating frequency of the first radiating element is greater than the operating frequency of the second radiating element. The third conductive part may be disposed at the center of the first radiating element, and the third conductive part and the first radiating element are connected to a common ground. The third conductive part is coupled to the first radiating element, and is configured to suppress common-mode resonance generated by the first radiating element in the second radiating element.

During specific application, the third conductive part may alternatively be disposed slightly away from the center of the first radiating element. Alternatively, it may be understood that the third conductive part may be located at the center of the first radiating element or in an area near the center.

In some implementations, the first radiating element may further perform feeding by using a balun. A main function of the balun is to convert and match an electrical signal that is relatively balanced with a reference ground and an electrical signal that is relatively unbalanced with the reference ground, to improve a matching degree between the first radiating element and a feeding network, thereby improving signal transmission quality of the first radiating element.

It should be noted that, during specific implementation, the balun may be correspondingly disposed by using a currently conventional type, and details are not described herein.

In addition, in some implementations, the third conductive part may be further electrically connected to the balun, so that a phase of a current in the third conductive part is opposite to a phase of a current in the balun, and the currents can cancel each other, to effectively suppress common-mode resonance.

In addition, when the third conductive part is disposed, a length of the third conductive part may be properly adjusted based on an actual requirement.

For example, the length of the third conductive part may be greater than or equal to 0.25 times the operating wavelength of the first radiating element.

In addition, it is found, by considering impact of a standing wave and by comparing massive experiments and data, that if the length of the third conductive part is slightly greater than 0.25 times the operating wavelength of the first radiating element, the third conductive part can be better coupled to the first radiating element, to effectively suppress the high-frequency current in the first radiating element. Certainly, during specific implementation, the length of the third conductive part may be 0.26 times, 0.27 times, 0.28 times, or the like the operating wavelength of the first radiating element. This is not specifically limited in this application.

Alternatively, it may be understood that, during specific application, structures of the third conductive part and the first conductive part may be the same or roughly the same, and details are not described herein.

In addition, in an implementation, the first conductive part, the second conductive part, and the third conductive part may be of a long strip structure. For example, the conductive part may be manufactured by using a metal (for example, copper or aluminum) or another non-metallic material with good conductivity. During manufacturing, preparation processes such as die casting and cutting may be used for manufacturing. Alternatively, the conductive part may be a printed circuit board. Structure types of the first conductive part, the second conductive part, and the third conductive part may be the same or may be different. This is not limited in this application.

It may be understood that, during specific application, only the first conductive part, only the second conductive part, or only the third conductive part may be disposed in the antenna. Alternatively, at least any two of the conductive parts may simultaneously be disposed.

During specific application, the antenna may further include a reflective plate, and the reflective plate generally has a front surface (or a reflective surface) and a back surface (a surface back away from the front surface). The front surface may provide installation locations for the radiating elements (for example, the first radiating element and the second radiating element), and can further effectively improve signal receiving and sending performance of the radiating elements. In addition, the reflective plate can further block and shield another electromagnetic signal from the back surface, to achieve a specific anti-interference effect for the radiating elements.

In addition, to implement a common ground connection between the first conductive part and the first radiating element, both the first conductive part and the first radiating element may be electrically connected to a common ground point on the reflective plate.

Correspondingly, to implement a common ground connection between the second conductive part and the second radiating element, both the second conductive part and the second radiating element may be electrically connected to a common ground point on the reflective plate.

Correspondingly, to implement a common ground connection between the third conductive part and the first radiating element, both the third conductive part and the first radiating element may be electrically connected to a common ground point on the reflective plate.

According to another aspect, this application further provides a communication device, including any one of the foregoing antennas. During specific application, the communication device may be a base station, a radar, or the like. A type of the communication device is not limited in this application. Alternatively, it may be understood as that the antenna may be used in a plurality of different types of communication devices. Beneficial effects corresponding to this aspect have been described in the foregoing aspect, and details are not described herein again.

### BRIEF DESCRIPTION OF DRAWINGS

FIG. 1 is a schematic diagram of an application scenario of an antenna according to an embodiment of this application;

FIG. 2 is a schematic diagram of a structure of a base station antenna system according to an embodiment of this application;

FIG. 3 is a schematic diagram of a structure of an antenna according to an embodiment of this application;

FIG. 4 is a schematic diagram of a three-dimensional structure of a first radiating element and a first conductive part of an antenna according to an embodiment of this application;

FIG. 5 is a schematic diagram of a three-dimensional structure of a first radiating element and a first conductive part of another antenna according to an embodiment of this application;

FIG. 6 is a schematic diagram of a three-dimensional structure of a first radiating element and a first conductive part of another antenna according to an embodiment of this application;

FIG. 7 is a data simulation comparison diagram according to an embodiment of this application;

FIG. 8 is a schematic diagram of a side structure of an antenna according to an embodiment of this application;

FIG. 9 is a schematic diagram of a three-dimensional structure of a second radiating element and a second conductive part of an antenna according to an embodiment of this application;

FIG. 10 is another data simulation comparison diagram according to an embodiment of this application;

FIG. 11 is a schematic diagram of a three-dimensional structure of another antenna according to an embodiment of this application;

FIG. 12 is a schematic diagram of a structure of a second conductive part according to an embodiment of this application;

FIG. 13 is another data simulation comparison diagram according to an embodiment of this application;

FIG. 14 is a schematic diagram of a structure of another second conductive part according to an embodiment of this application;

FIG. 15 is a schematic diagram of a structure of another second conductive part according to an embodiment of this application;

FIG. 16 is a schematic diagram of a structure of another second conductive part according to an embodiment of this application;

FIG. 17 is a schematic diagram of a side structure of another antenna according to an embodiment of this application; and

FIG. 18 is a schematic diagram of a three-dimensional structure of a radiating element and a third conductive part of another antenna according to an embodiment of this application.

### DESCRIPTION OF EMBODIMENTS

To make objectives, technical solutions, and advantages of this application clearer, the following further describes this application in detail with reference to the accompanying drawings.

To facilitate understanding of an antenna provided in embodiments of this application, the following first describes an application scenario of the antenna.

The antenna provided in embodiments of this application may be used in a communication device like a base station or radar, to implement a wireless communication function.

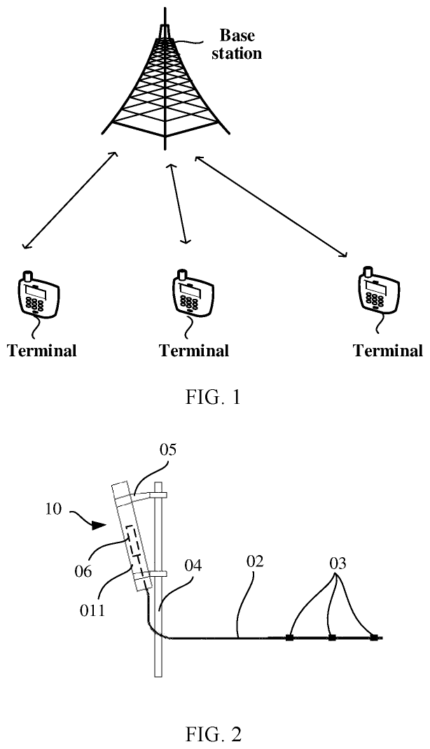

As shown in FIG. 1, the application scenario may include the base station and a terminal. Wireless communication may be implemented between the base station and the terminal. The base station may be located in a base station subsystem (base station subsystem, BBS), a terrestrial radio access network (UMTS terrestrial radio access network, UTRAN), or an evolved terrestrial radio access network (evolved universal terrestrial radio access, E-UTRAN), and is configured to perform cell coverage of a radio signal, to implement communication between the terminal device and a wireless network. Specifically, the base station may be a base transceiver station (base transceiver station, BTS) in a global system for mobile communications (global system for mobile communications, GSM) or a code division multiple access (code division multiple access, CDMA) system, or may be a NodeB (NodeB, NB) in a wideband code division multiple access (wideband code division multiple access, WCDMA) system, or may be an evolved NodeB (evolved NodeB, eNB or eNodeB) in a long term evolution (long term evolution, LTE) system, or may be a radio controller in a cloud radio access network (cloud radio access network, CRAN) scenario. Alternatively, the base station may be a relay station, an access point, a vehicle-mounted device, a wearable device, a g node (gNodeB or gNB) in a new radio (new radio, NR) system, a base station in a future evolved network, or the like. This is not limited in embodiments of this application.

As shown in FIG. 2, a base station provided in embodiments of this application includes a base station antenna system. During actual application, the base station antenna system mainly includes an antenna 10, a feeder 02, a grounding apparatus 03, and the like. The antenna 10 is generally fastened on a holding pole 04, and downtilt of the antenna 10 may be adjusted by using an antenna adjustment bracket 05, to adjust a signal coverage area of the antenna 10 to some extent.

In addition, the base station may further include a radio frequency processing unit 06 and a baseband processing unit. For example, the radio frequency processing unit 06 may be configured to: perform frequency selection, amplification, and down-conversion processing on a signal received by the antenna 10, convert the signal into an intermediate frequency signal or a baseband signal, and send the intermediate frequency signal or the baseband signal to the baseband processing unit. Alternatively, the radio frequency processing unit 06 is configured to: perform up-conversion and amplification processing on the baseband signal or an intermediate frequency signal, convert the the baseband signal or the intermediate frequency signal into a radio signal by using the antenna 10, and send the radio signal by using the antenna 10. The baseband processing unit may be connected to a feeding network of the antenna 10 through the radio frequency processing unit 06. In some implementations, the radio frequency processing unit may also be referred to as a remote radio unit (remote radio unit, RRU), and the baseband processing unit may also be referred to as a baseband unit (baseband unit, BBU).

As shown in FIG. 2, in a possible embodiment, the radio frequency processing unit 06 and the antenna 10 may be integrally disposed. The baseband processing unit is located at a remote end of the antenna 10. In another embodiment, both the radio frequency processing unit 06 and the baseband processing unit may be located at a remote end of the antenna 10. The radio frequency processing unit 06 and the baseband processing unit may be connected through the feeder 02.

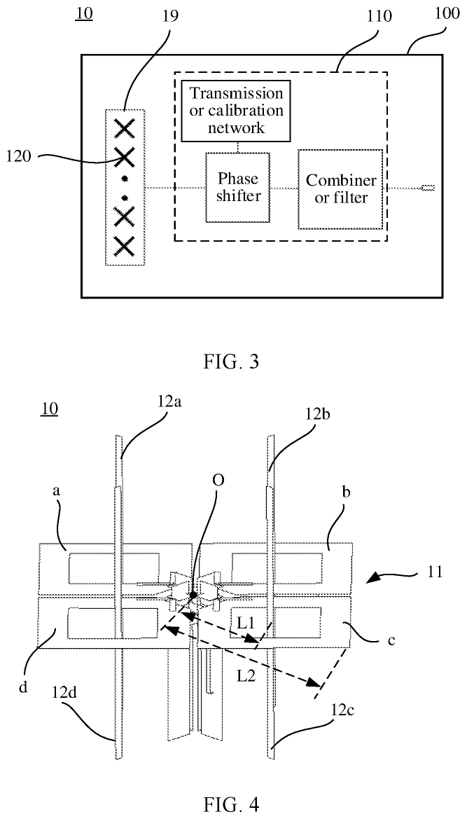

Refer to FIG. 2 and FIG. 3. The antenna 10 used in the base station may include a housing 100, and a reflective plate 19 and a feeding network 110 that are located in the housing 100. A main function of the feeding network is to feed a signal to a radiating element 120 based on a specific amplitude and phase, or send, to the baseband processing unit of the base station based on a specific amplitude and phase, a radio signal received by the radiating element 120. It may be understood that, during specific implementation, the feeding network 110 may include at least one of a phase shifter, a combiner, a transmission or calibration network, a filter, or another component. Components and types of the feeding network 110 and functions that can be implemented by the feeding network 110 are not limited in this application.

Certainly, the antenna 10 may be further used in a plurality of other types of communication devices. An application scenario of the antenna 10 is not limited in this application.

The housing 100 may also be referred to as a radome. In terms of electrical performance, the housing 100 has good electromagnetic wave penetrability. In this way, normal receiving and sending of an electromagnetic signal between the radiating element 120 and the outside are not affected. In terms of mechanical performance, the housing 100 has good force-bearing performance, anti-oxidation performance, and the like. In this way, the housing 100 can withstand corrosion of an external harsh environment.

The radiating element 120 may also be referred to as an antenna element, and is a unit that forms a basic structure of the antenna. The radiating element 120 can effectively transmit or receive an electromagnetic wave. A plurality of radiating elements 120 may form an array for use. During specific application, the antenna element may be classified into a single-polarization type, a dual-polarization type, and the like. During specific configuration, a type of the antenna element may be properly selected based on an actual requirement.

The reflective plate 19 is also referred to as a bottom plate. The reflective plate 19 generally has a front surface (or a reflective surface) and a back surface (a surface back away from the front surface). The front surface may provide an installation location for the radiating element 120, and can further effectively improve signal receiving and sending performance of the radiating element 120. In addition, the reflective plate 19 can further block and shield another electromagnetic signal from the back surface, to achieve a specific anti-interference effect for the radiating element 120.

During actual application, performance of the antenna 10 directly affects performance of the entire antenna system. Therefore, when the antenna 10 is configured, the performance of the antenna 10 needs to meet a corresponding requirement. Main parameters of the performance of the antenna 10 include a gain, a beam width, and the like. In some application scenarios, the antenna 10 needs to have a large gain. Currently, in some antennas 10, a structure like a director is configured in the antenna 10 to increase a gain of the antenna 10. However, this manner increases a height of a cross section of the antenna 10, and is not conducive to a miniaturization design of the antenna 10.

Therefore, embodiments of this application provide an antenna 10 that can narrow a beam width and increase a gain. In addition, the antenna 10 has a simple structure, is easy to be manufactured, and is conducive to reduce a height of a cross section and conducive to a miniaturization design.

To make the objectives, technical solutions, and advantages of this application clearer, the following further describes this application in detail with reference to the accompanying drawings and specific embodiments.

Terms used in the following embodiments are merely intended to describe particular embodiments, but are not intended to limit this application. Terms “one”, “a”, and “the” of singular forms used in this specification and the appended claims of this application are also intended to include expressions such as “one or more”, unless otherwise specified in the context clearly. It should be further understood that, in the following embodiments of this application, “at least one” means one, two, or more.

Reference to “an embodiment” or the like described in this specification means that one or more embodiments of this application include a particular feature, structure, or characteristic described with reference to the embodiment. Therefore, statements such as “in an embodiment”, “in some implementations”, and “in another implementation” that appear at different places in this specification do not necessarily mean referring to a same embodiment. Instead, the statements mean “one or more but not all of embodiments”, unless otherwise specifically emphasized in another manner. Terms “include”, “have”, and variants thereof all mean “include but are not limited to”, unless otherwise specifically emphasized in another manner.

As shown in FIG. 4, in an embodiment provided in this application, an antenna 10 includes a first radiating element 11 and a first conductive part. The first radiating element 11 is configured to transmit or receive a radio signal (namely, the electromagnetic wave described above, which is uniformly represented as the radio signal below). Refer to FIG. 3. The first conductive part and the first radiating element 11 may be connected to a common ground by using the reflective plate 19. Specifically, the first radiating element 11 shown in FIG. 4 is a dual-polarization radiating element, and includes four radiating arms: a radiating arm a, a radiating arm b, a radiating arm c, and a radiating arm d. The radiating arm a and the radiating arm c are located in a polarization direction, and the radiating arm b and the radiating arm d are located in another polarization direction. Four first conductive parts are disposed: a first conductive part 12a, a first conductive part 12b, a first conductive part 12c, and a first conductive part 12d. The four first conductive parts are disposed in an annular shape around a center O of the first radiating element 11. In addition, a distance between the first conductive part and the center O of the first radiating element 11 is L1, a maximum distance between the first radiating element 11 and the center O is L2, and L1≤L2. In this way, the first conductive part is coupled to the first radiating element 11, so that a beam width of the first radiating element 11 is narrowed. It should be noted that the term “coupling” in this application is “electromagnetic coupling”, and means a phenomenon that two or more elements closely cooperate with each other and affect each other, and energy is transferred from one side to the other side through interaction.

In this embodiment, two first conductive parts may be disposed in each polarization direction of the first radiating element 11, and the two first conductive parts are disposed in an annular shape around the center of the first radiating element 11.

Alternatively, the first radiating element 11 may be a single-polarization radiating element. When the first radiating element 11 is the single-polarization radiating element, it is equivalent that the first radiating element 11 has only two arms shown in FIG. 4. For example, the first radiating element 11 may have a radiating arm a and a radiating arm c; or may have a radiating arm b and a radiating arm d. In this case, two first conductive parts may be configured, and the two first conductive parts are disposed in an annular shape around the center of the first radiating element 11.

It should be noted that, in this embodiment of this application, the center of the first radiating element 11 may be understood as a geometric center of the first radiating element 11. In addition, that the first conductive parts are disposed in an annular shape around the center of the first radiating element 11 means that distances between all the first conductive parts and the center of the first radiating element 11 are the same. In addition, a plurality of first conductive parts may be disposed in an equidistant manner, that is, distances between two adjacent first conductive parts are the same, to ensure symmetry of a directivity pattern of a radiation field corresponding to the first radiating element 11. It may be understood that, in another implementation, when the first conductive parts are disposed in an annular shape around the center of the first radiating element 11, a non-equidistant disposing manner may be used for implementation. In addition, the first conductive parts and the first radiating element 11 may alternatively be disposed in a non-annular manner. For example, distances between all the first conductive parts and the center of the first radiating element 11 may be different. This is not limited in this application.

Certainly, a quantity of first conductive parts configured for one first radiating element is not limited to the foregoing example. More generally, the quantity may be 2N, where N is a positive integer. To be specific, in another implementation, four, six, eight, ten, or more first conductive parts may be disposed in the first radiating element 11. A specific quantity of disposed first conductive parts is not limited in this application.

When the first radiating element 11 is of a dual-polarization type, a quantity of first conductive parts configured for one first radiating element may be further represented as 4N, where N is a positive integer.

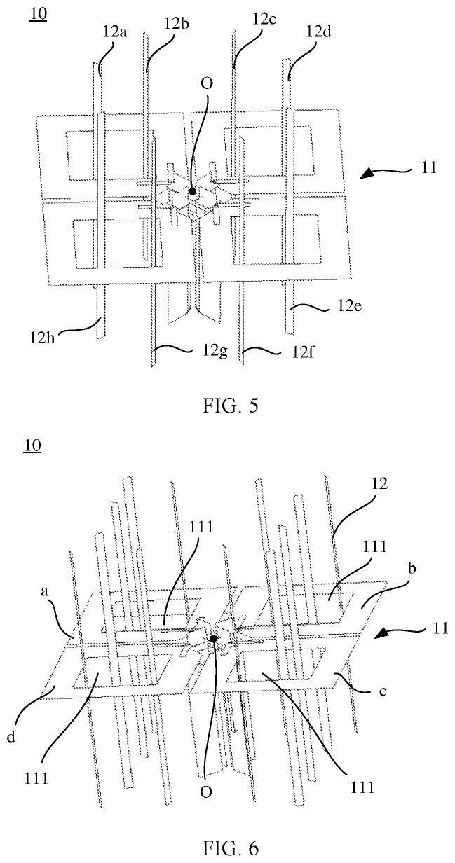

For example, as shown in FIG. 5, eight first conductive parts may be disposed in the first radiating element 11: a first conductive part 12a, a first conductive part 12b, a first conductive part 12c, a first conductive part 12d, a first conductive part 12e, a first conductive part 12f, a first conductive part 12g, and a first conductive part 12h. In addition, the eight first conductive parts are disposed in an annular shape around the center of the first radiating element 11.

For another example, as shown in FIG. 6, 12 first conductive parts 12 may be disposed in the first radiating element 11 (where only one first conductive part 12 is marked in the figure), and the 12 first conductive parts 12 are disposed in an annular shape around the center of the first radiating element 11. It may be understood that a reference mark of the first conductive part in FIG. 6 is 12. In FIG. 4 and FIG. 5, for ease of understanding the technical solutions of this application, different first conductive parts are distinguished in a form of letters (such as a and b) added after the reference mark 12. In the following related descriptions, the first conductive part 12 may also be understood as the first conductive part 12a, 12b, 12c, or the like.

It may be understood that, in another implementation, 16, 20, or more first conductive parts 12 may be disposed in the first radiating element 11. A specific quantity of disposed first conductive parts 12 is not limited in this application.

In summary, during actual application, when the first conductive part 12 is configured, 2N first conductive parts 12 may be correspondingly disposed in one polarization direction of the first radiating element 11, and the 2N first conductive parts 12 may be disposed in an annular shape around the geometric center of the first radiating element 11, where N is a positive integer.

In the antenna 10 provided in this application, the beam width of the first radiating element 11 can be effectively narrowed by configuring the first conductive part 12, and a height of a cross section of the antenna 10 is not significantly increased. In addition, the first conductive part 12 has a simple structure, and is easy to be processed. This is conducive to low-cost implementation, and is conducive to manufacturing and wide application. That the first conductive part 12 can narrow the beam width of the first radiating element 11 is specifically as follows: When the first radiating element 11 transmits the radio signal, an induced current is generated on the first conductive part 12. In addition, the induced current can further enable the first conductive part 12 to generate a radio signal. Because a phase of the induced current and a phase of a current on the first radiating element 11 are the same, a phase of the radio signal generated by the first conductive part 12 and a phase of the radio signal generated by the first radiating element 11 are the same, and the two signals are superposed to narrow the beam width. For example, when the radiating arm a and the radiating arm c on the first radiating element 11 transmit a radio signal, an induced current is generated on the conductive part 12a and the conductive part 12c. A phase of the radio signal generated by the radiating arm a and the radiating arm c and a phase of the radio signal generated by the conductive part 12a and the conductive part 12c are the same, and the two signals are superposed to narrow the beam width.

In addition, it may be understood that during specific application, there may be various structure shapes of the first radiating element 11. For example, in embodiments provided in this application, an edge profile of the first radiating element 11 is approximately a square. In another implementation, the first radiating element 11 may be of another structure type such as an ellipse, a circle, or a rectangle. This is not limited in this application.

In addition, during specific application, there may be various relative locations between the first conductive part 12 and the first radiating element 11.

For example, in embodiments provided in this application, each of the radiating arm a, the radiating arm b, the radiating arm c, and the radiating arm d of the first radiating element 11 is provided with one through hole 111, and each through hole 111 is penetrated by three first conductive parts 12.

Alternatively, it may be understood that, when the distance L1 between the first conductive part 12 and the center of the radiating element is less than the maximum distance L2 between the radiating element and the center of the radiating element, the radiating element may be provided with a through hole 111 for the first conductive part 12 to penetrate, to avoid interference between the first conductive part 12 and the radiating element.

During specific application, a shape and a location of the through hole 111 and a quantity of through holes may be properly set based on an actual requirement. In addition, each through hole 111 may be penetrated by only one first conductive part 12, or may be simultaneously penetrated by a plurality of first conductive parts 12. This is not specifically limited in this application.

It may be understood that, in another implementation, the first conductive part 12 may be disposed close to an edge of the first radiating element 11. During specific application, the relative location between the first conductive part 12 and the radiating element may be properly adjusted based on an actual requirement. This is not limited in this application.

In addition, as shown in FIG. 4, a specific value of L1 may be properly set based on an actual situation.

For example, in embodiments provided in this application, L1 may be less than or equal to 0.1 times an operating wavelength of the first radiating element 11. The distance between the first conductive part and the center of the first radiating element 11 is properly adjusted, so that a coupling effect between the first conductive part and the first radiating element 11 can be effectively improved, thereby effectively narrowing the beam width of the first radiating element 11 and increasing a gain of the first radiating element 11. The operating wavelength of the first radiating element 11 is a wavelength corresponding to a frequency of the radio signal transmitted or received by the first radiating element 11.

In addition, when the first conductive part is disposed, a length of the first conductive part may also be properly adjusted based on an actual requirement.

For example, in embodiments provided in this application, the first conductive part is in a linear shape, and the length of the first conductive part may be greater than or equal to 0.25 times the operating wavelength of the first radiating element 11.

In addition, it is found, by considering impact of a standing wave and by comparing massive experiments and data, that if the length of the first conductive part is slightly greater than 0.25 times the operating wavelength of the first radiating element 11, the first conductive part can be better coupled to the first radiating element 11, to significantly narrow the beam width of the first radiating element 11. Therefore, during specific implementation, the length of the first conductive part may be 0.26 times, 0.27 times, 0.28 times, or the like the operating wavelength of the first radiating element 11. This is not specifically limited in this application. Certainly, during specific application, lengths of the plurality of first conductive parts may be the same or may be different. This is not specifically limited in this application.

In addition, when the first conductive part is disposed, there may be various shapes of the first conductive part.

For example, as shown in FIG. 6, in embodiments provided in this application, the first conductive part 12 is of a linear shape, or referred to as a strip shape. During specific implementation, the first conductive part 12 may be manufactured by using a metal (for example, copper or aluminum) or another non-metallic material with good conductivity. During manufacturing, preparation processes such as die casting and cutting may be used for manufacturing. Alternatively, the first conductive part 12 may be a printed circuit board.

Certainly, during specific implementation, the first conductive part 12 may be manufactured by using another conductive material or another preparation process. This is not limited in this application.

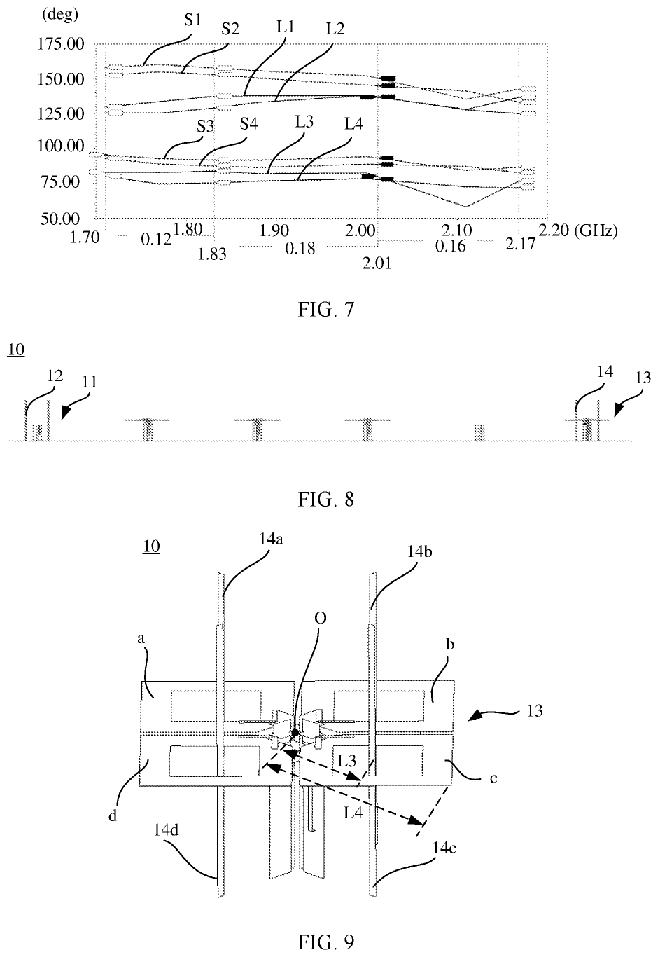

To more clearly describe a beneficial technical effect of narrowing the beam width of the first radiating element 11 after the first conductive part 12 is disposed, embodiments of this application further provides a data simulation comparison diagram. As shown in FIG. 7, in the figure, a horizontal coordinate represents an operating frequency in a unit of GHz, and a vertical coordinate represents a beam width in a unit of degree (deg). Dashed lines S1 to S4 each represent a simulation curve of the beam width that is of the first radiating element 11 and that changes with the operating frequency when no first conductive part 12 is disposed. Solid lines L1 to L4 each represent a simulation curve of the beam width that is of the first radiating element 11 and that changes with the operating frequency after the first conductive part 12 is disposed. With reference to FIG. 4 and FIG. 7, it can be clearly seen, by comparing S1 and L1, that after the first conductive part 12a and the first conductive part 12c are disposed in the first radiating element 11, if a radiated power decreased by 10 dB is used as a standard, the beam width is narrowed by more than 20 degrees in the polarization direction formed by the radiating arm a and the radiating arm c.

It can be clearly seen, by comparing S2 and L2, that after the first conductive part 12b and the first conductive part 12d are disposed in the first radiating element 11, if a radiated power decreased by 10 dB is used as a standard, the beam width is narrowed by more than 20 degrees in the polarization direction formed by the radiating arm b and the radiating arm d.

It can be clearly seen, by comparing S3 and L3, that after the first conductive part 12a and the first conductive part 12c are disposed in the first radiating element 11, if a radiated power decreased by 3 dB is used as a standard, the beam width is narrowed by more than 20 degrees in the polarization direction formed by the radiating arm a and the radiating arm c.

It can be clearly seen, by comparing S4 and L4, that after the first conductive part 12b and the first conductive part 12d are disposed in the first radiating element 11, if a radiated power decreased by 3 dB is used as a standard, the beam width is narrowed by more than 20 degrees in the polarization direction formed by the radiating arm b and the radiating arm d.

In addition, as shown in FIG. 8, during specific application, the antenna 10 may further include a second radiating element 13. The operating frequency of the first radiating element 11 may be greater than an operating frequency of the second radiating element 13. It may be understood that, a plurality of radiating elements with different operating frequencies are configured in the antenna 10, so that a bandwidth of the antenna 10 can be effectively increased.

It should be noted that, during specific application, operating frequencies of the radiating elements (for example, the first radiating element 11 and the second radiating element 13) are within a frequency range, instead of being a specific frequency. Therefore, that the operating frequency of the first radiating element 11 is greater than the operating frequency of the second radiating element 13 may also be understood as that a maximum operating frequency of the first radiating element 11 is greater than a maximum operating frequency of the second radiating element 13.

In an implementation, a second conductive part 14 may be disposed in the second radiating element 13, to narrow the beam width of the antenna 10 and increase the gain.

It may be understood that the first radiating element 11 and the second radiating element 13 may be understood as two radiating elements with different operating frequencies. In addition, the first conductive part 12 is a conductive part that is disposed in correspondence to the first radiating element 11, and the second conductive part 14 is a conductive part that is disposed in correspondence to the second radiating element 13.

A manner of disposing the second conductive part 14 relative to the second radiating element 13 may be the same as or similar to a manner of disposing the first conductive part 12 relative to the first radiating element 11. For example, as shown in FIG. 9, in an embodiment provided in this application, four second conductive parts are disposed: a second conductive part 14a, a second conductive part 14b, a second conductive part 14c, and a second conductive part 14d. The four second conductive parts are disposed in an annular shape around a center O of the second radiating element 13. In addition, a distance between the second conductive part and the center O of the second radiating element 13 is L3, a maximum distance between the second radiating element 13 and the center O is L4, and L3≤L4. In this way, the second conductive part is coupled to the second radiating element 13, so that a beam width of the second radiating element 13 is narrowed.

During actual application, the second conductive part 14 and the first conductive part 12 may have a same structure or a roughly same structure.

To more clearly describe a beneficial technical effect of narrowing the beam width of the second radiating element 13 after the second conductive part 14 is disposed, embodiments of this application further provides a data simulation comparison diagram.

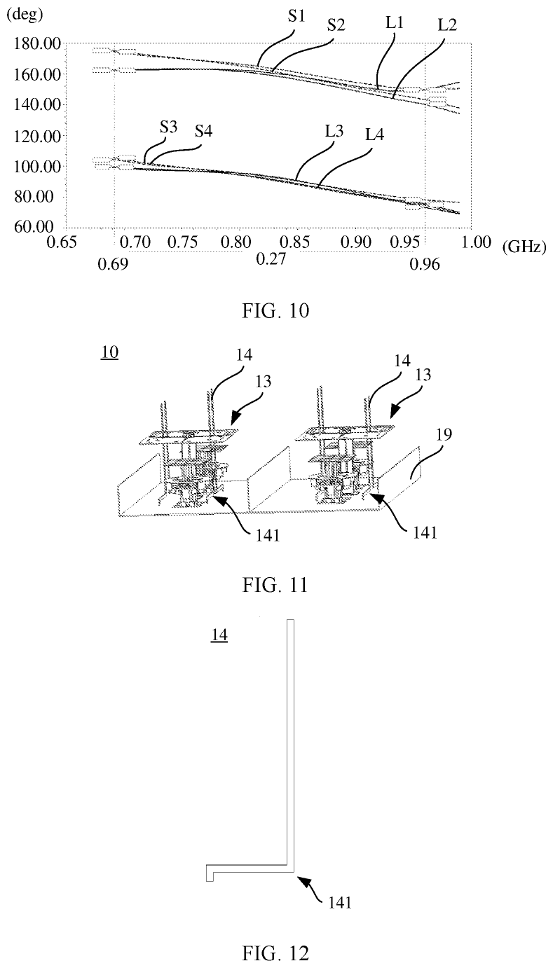

As shown in FIG. 10, in the figure, a horizontal coordinate represents an operating frequency in a unit of GHz, and a vertical coordinate represents a beam width in a unit of deg.

Dashed lines S1 to S4 each represent a simulation curve of the beam width that is of the second radiating element 13 and that changes with the operating frequency when no second conductive part 14 is disposed.

Solid lines L1 to L4 each represent a simulation curve of the beam width that is of the second radiating element 13 and that changes with the operating frequency after the second conductive part 14 is disposed.

With reference to FIG. 9 and FIG. 10, it can be clearly seen, by comparing S1 and L1, that after the second conductive part 14a and the second conductive part 14c are disposed in the second radiating element 13, if a radiated power decreased by 10 dB is used as a standard, the beam width is narrowed by more than 10 degrees in the polarization direction formed by the radiating arm a and the radiating arm c.

It can be clearly seen, by comparing S2 and L2, that after the second conductive part 14b and the second conductive part 14d are disposed in the second radiating element 13, if a radiated power decreased by 10 dB is used as a standard, the beam width is narrowed by more than 20 degrees in the polarization direction formed by the radiating arm b and the radiating arm d.

It can be clearly seen, by comparing S3 and L3, that after the second conductive part 14a and the second conductive part 14c are disposed in the second radiating element 13, if a radiated power decreased by 3 dB is used as a standard, the beam width is narrowed by more than 20 degrees in the polarization direction formed by the radiating arm a and the radiating arm c.

It can be clearly seen, by comparing S4 and L4, that after the second conductive part 14b and the second conductive part 14d are disposed in the second radiating element 13, if a radiated power decreased by 3 dB is used as a standard, the beam width is narrowed by more than 20 degrees in the polarization direction formed by the radiating arm b and the radiating arm d.

In addition, after the second conductive part 14 is disposed for the second radiating element 13, when generating the radio signal, the first radiating element 11 generates an induced current in the second conductive part 14. Because a phase of the induced current is opposite to a phase of a current in the first radiating element 11, signal transmission efficiency of the first radiating element 11 is reduced, and the signal of the first radiating element 11 is interfered. Therefore, during actual application, a filtering structure may be disposed in the second conductive part 14, to suppress the induced current in the second conductive part 14, thereby reducing interference caused by the second conductive part 14 to signal transmission of the first radiating element 11.

As shown in FIG. 11, in embodiments provided in this application, a filtering structure 141 is disposed in the second conductive part 14, so that an induced current generated in the second conductive part 14 by a radio signal, with a high frequency, generated by the first radiating element 11 can be suppressed, thereby improving signal transmission efficiency and transmission quality of the first radiating element 11.

Because the operating frequency of the first radiating element 11 is greater than the operating frequency of the second radiating element 13, in an embodiment provided in this application, the filtering structure 141 is specifically of an inductor structure, and a high-frequency current flowing through the second conductive part 14 can be suppressed by using characteristics of low-frequency pass-through and high-frequency resistance of the inductor structure. Alternatively, it may be understood as that the inductor structure may suppress the induced current generated in the second conductive part 14 by the radio signal generated by the first radiating element 11.

During specific implementation, there may be various types of the filtering structure 141. For example, the filtering structure 141 may be of the inductor structure, or may be another device, for example, a filter, that can suppress the high-frequency current.

For example, as shown in FIG. 11 and FIG. 12, in an embodiment provided in this application, the filtering structure 141 is of the inductor structure. Specifically, the second conductive part 14 may be bent to form the inductor structure. The high-frequency current can be suppressed by using the characteristics of low-frequency pass-through and high-frequency resistance of the inductor structure.

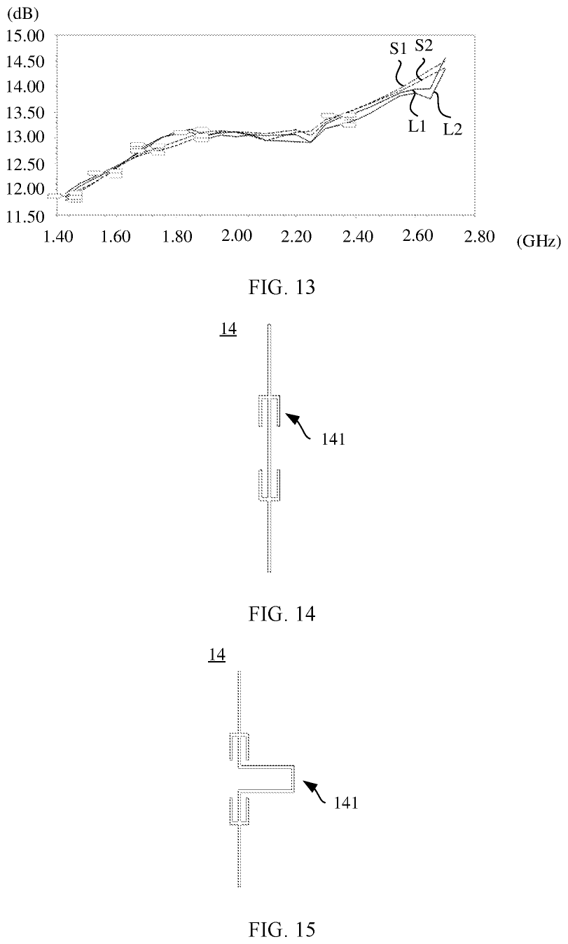

As shown in FIG. 13, a horizontal coordinate represents an operating frequency in a unit of GHz, and a vertical coordinate represents a gain in a unit of dB.

Dashed lines S1 and S2 each represent a simulation curve of the gain that is of the first radiating element 11 and that changes with the operating frequency when no second conductive part 14 is disposed.

Solid lines L1 and L2 each represent a simulation curve of the gain that is of the first radiating element 11 and that changes with the operating frequency after the second conductive part 14 having the filtering structure is disposed.

With reference to FIG. 9, FIG. 11, and FIG. 13, it can be clearly seen, by comparing S1 and L1, that after the second conductive part 14a and the second conductive part 14c that each have the filtering structure are disposed in the second radiating element 13, the gain of the first radiating element 11 does not change significantly. In other words, the second conductive part 14a and the second conductive part 14c that each have the filtering structure do not significantly affect the gain of the first radiating element 11.

It can be clearly seen, by comparing S2 and L2, that after the second conductive part 14b and the second conductive part 14d that each have the filtering structure are disposed in the second radiating element 13, the gain of the first radiating element 11 does not change significantly. In other words, the second conductive part 14b and the second conductive part 14d that each have the filtering structure do not significantly affect the gain of the first radiating element 11.

Certainly, during specific implementation, there may be various structure forms of the filtering structure 141.

For example, as shown in FIG. 14, the filtering structure 141 may alternatively be a fork structure. In embodiments provided in this application, two fork structures are disposed, and the two fork structures are symmetrically disposed.

Certainly, in another implementation, one fork structure may be disposed, or three or more fork structures may be disposed. This is not limited in this application.

Alternatively, as shown in FIG. 15, the filtering structure 141 may include a bent structure and a fork structure.

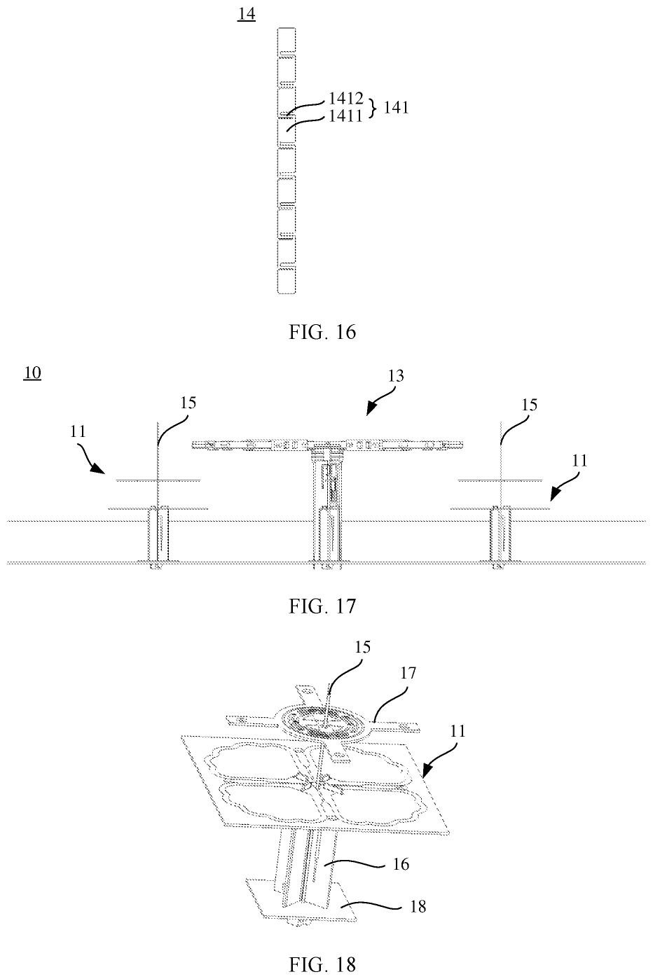

Alternatively, as shown in FIG. 16, the filtering structure 141 may include a wide-narrow connection structure. Specifically, the filtering structure 141 may include a wide part 1411 with a large cross section and a narrow part 1412 with a small cross section. The wide part 1411 and the narrow part 1412 are sequentially connected, to form the inductor structure, thereby suppressing the high-frequency current.

In summary, during specific implementation, the filtering structure 141 may include one of the wide-narrow connection structure, the fork structure, or the bent structure, or a combination of at least two of the structures.

In addition, in another implementation, the second conductive part 14 may include another type of filtering structure 141 that can suppress a current with a high frequency. This is not specifically limited in this application.

It may be understood that, during specific application, two or more radiating elements may be disposed in the antenna 10. In addition, in a plurality of radiating elements, a conductive part (for example, the first conductive part 12 or the second conductive part 14 mentioned above) may be disposed in each radiating element. Alternatively, conductive parts are disposed in some radiating elements. In addition, in the plurality of radiating elements, operating frequencies of all the radiating elements may be the same, or an operating frequency of at least one radiating element is different from operating frequencies of other radiating elements. In addition, for the first conductive part 12, a filtering structure that is the same as or roughly the same as that in the second conductive part 14 may also be disposed. This is not limited in this application.

With continuous innovation of communication technologies, the antenna is also developing toward miniaturization and high integrity. For example, the antenna may include a plurality of radiating elements, and the plurality of radiating elements operating in different frequencies need to be closely arranged to reduce a size of an antenna unit. When the plurality of radiating elements are closely arranged, a clear coupling phenomenon easily occurs between the radiating elements operating in different frequencies, and communication quality of the entire antenna is significantly affected.

The clear coupling phenomenon occurs between the radiating elements operating in different frequencies is also referred to as common-mode resonance between the different radiating elements in the antenna.

In some antennas, a tuning circuit is introduced to suppress common-mode resonance. However, using the tuning circuit makes a structure of the antenna become complex, and increases processing difficulty and matching difficulty. Therefore, this is not conducive to actual application.

An operating frequency of a radiating element is determined by a structure and a boundary of the radiating element. In a multi-frequency antenna, generally, a size of a low-frequency radiating element is large, and a size of a high-frequency radiating element is small. A radio signal radiated by the high-frequency radiating element easily generates common-mode resonance with the low-frequency radiating element, affecting normal operation and radiation performance of the low-frequency radiating element. From a perspective of a directivity pattern, a directivity pattern of the low-frequency radiating element is distorted.

To resolve the foregoing problem, as shown in FIG. 17 and FIG. 18, in an embodiment provided in this application, the antenna 10 may further include a third conductive part 15. The third conductive part 15 and a radiating element operating in a high frequency may be connected to a common ground, and is configured to suppress common-mode resonance generated by a radio signal with a high frequency in a radiating element operating in a low frequency.

Specifically, in embodiments provided in this application, the operating frequency of the first radiating element 11 is greater than the operating frequency of the second radiating element 13. The third conductive part 15 is disposed at the center of the first radiating element 11, and the third conductive part 15 and the first radiating element 11 are connected to a common ground. The third conductive part 15 is coupled to the first radiating element 11, and is configured to suppress common-mode resonance generated by the first radiating element 11 in a frequency in which the second radiating element 13 is located. For example, when the second radiating element 13 generates a radio signal, the first radiating element 11 is coupled to the second radiating element 13. Therefore, an induced current is generated on the first radiating element 11, and the induced current deteriorates performance of the second radiating element 13. After the third conductive part 15 is disposed at the center of the first radiating element 11, when the second radiating element 13 generates the radio signal, the first radiating element 11 and the third conductive part 15 induce induced currents with opposite phases, and the two circuits cancel each other, to reduce impact on the second radiating element 13.

During specific application, the third conductive part 15 may alternatively be disposed slightly away from the center of the first radiating element 11. Alternatively, it may be understood that the third conductive part 15 may be located at the center of the first radiating element 11 or in an area near the center.

In addition, when the third conductive part 15 is disposed, a length of the third conductive part 15 may also be properly adjusted based on an actual requirement.

For example, in embodiments provided in this application, the length of the third conductive part 15 may be greater than or equal to 0.25 times the operating wavelength of the first radiating element 11.

In addition, it is found, by considering impact of a standing wave and by comparing massive experiments and data, that if the length of the third conductive part 15 is slightly greater than 0.25 times the operating wavelength of the first radiating element 11, the third conductive part 15 can be better coupled to the first radiating element 11, to effectively suppress the high-frequency current in the first radiating element 11. Certainly, during specific implementation, the length of the third conductive part 15 may be 0.26 times, 0.27 times, 0.28 times, or the like the operating wavelength of the first radiating element 11. This is not specifically limited in this application.

During specific implementation, the third conductive part 15 may be of a long strip structure, and the third conductive part 15 may be manufactured by using a metal (for example, copper or aluminum) or another non-metallic material with good conductivity. During manufacturing, preparation processes such as die casting and cutting may be used for manufacturing. Alternatively, the third conductive part 15 may be a printed circuit board.

Certainly, during specific implementation, the third conductive part 15 may be manufactured by using another conductive material or another preparation process. This is not limited in this application.

As shown in FIG. 18, in some implementations, the first radiating element 11 may further perform feeding by using a balun 16. A main function of the balun 16 is to convert and match an electrical signal that is relatively balanced with a reference ground and an electrical signal that is relatively unbalanced with the reference ground, to improve a matching degree between the first radiating element 11 and a feeding network, thereby improving signal transmission quality of the first radiating element 11.

It should be noted that, during specific implementation, the balun 16 may be disposed by using a currently conventional type, and details are not described herein.

In addition, in embodiments provided in this application, the third conductive part 15 may be further electrically connected to the balun 16, so that a phase of a current in the third conductive part 15 is opposite to a phase of a current in the balun 16, and the currents can cancel each other, to effectively suppress common-mode resonance.

Still refer to FIG. 18. In some implementations, the first radiating element 11 may be equipped with a director 17 to increase the gain of the first radiating element 11. It may be understood that, during specific implementation, a specific parameter, a type, and a disposing location of the director 17 may be properly adjusted based on an actual requirement. This is not specifically limited in this application.

In some implementations, both the first conductive part 12 and the third conductive part 15 may be disposed in the first radiating element 11.

During specific implementation, the third conductive part 15 and the first radiating element 11 may be connected to a common ground in a plurality of manners.

For example, as shown in FIG. 18, in some implementations, that the third conductive part 15 and the first radiating element 11 are connected to a common ground may be implemented by disposing an additional common ground plate 18. The common ground plate 18 may be a metal plate or a printed circuit board, or may be of another type of conductive structure. This is not limited in this application.

Alternatively, as shown in FIG. 11, in an embodiment provided in this application, the antenna 10 may include a reflective plate 19. The reflective plate 19 generally has a front surface (namely, a reflective surface) and a back surface (a surface back away from the front surface). The front surface may provide installation locations for the radiating elements (for example, the first radiating element 11 and the second radiating element 13), and can further effectively improve signal receiving and sending performance of the radiating elements. In addition, the reflective plate 19 can further block and shield another electromagnetic signal from the back surface, to achieve a specific anti-interference effect for the radiating elements.

During specific application, the reflective plate 19 is generally manufactured by using a conductive material like a metal. Therefore, when the third conductive part 15 and the first radiating element 11 are connected to a common ground, both the third conductive part 15 and the first radiating element 11 may be electrically connected to the reflective plate 19.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An antenna, comprising a first radiating element and a first conductive part, wherein
the first radiating element is configured to transmit or receive a radio signal;
the first conductive part and the first radiating element are connected to a common ground;
2N first conductive parts are correspondingly disposed in one polarization direction of the first radiating element, and N is a positive integer; and
a distance between the first conductive part and a center of the first radiating element is L1, a maximum distance from an edge of the first radiating element to the center is L2, and L1≤L2.

2. The antenna according to claim 1, wherein the first conductive part is configured to narrow a beam width of the first radiating element.

3. The antenna according to claim 1, wherein L1 is less than or equal to 0.1 times an operating wavelength of the first radiating element.

4. The antenna according to claim 1, wherein a length of the first conductive part is greater than or equal to 0.25 times the operating wavelength of the first radiating element.

5. The antenna according to claim 1, wherein the antenna further comprises a second radiating element; and
an operating frequency of the first radiating element is greater than an operating frequency of the second radiating element.

6. The antenna according to claim 5, wherein the antenna further comprises a second conductive part, and the second conductive part and the second radiating element are connected to a common ground;
2M second conductive parts are correspondingly disposed in one polarization direction of the second radiating element, and M is a positive integer; and
a distance between the second conductive part and a center of the second radiating element is L3, a maximum distance from an edge of the second radiating element to the center of the second radiating element is L4, and L3≤L4.

7. The antenna according to claim 6, wherein the second conductive part is configured to narrow a beam width of the second radiating element.

8. The antenna according to claim 6, wherein L3 is less than or equal to 0.1 times an operating wavelength of the second radiating element.

9. The antenna according to claim 6, wherein the second conductive part comprises a filtering structure, and the filtering structure is configured to filter the radio signal of the first radiating element, to reduce interference caused by the second conductive part to the radio signal of the first radiating element.

10. The antenna according to claim 9, wherein the filtering structure comprises at least one of a wide-narrow connection structure, a fork structure, or a bent structure.

11. The antenna according to claim 6, wherein the second conductive part is in a linear shape, or wherein the second conductive part is a metal strip or a printed circuit board.

12. The antenna according to claim 6, wherein the antenna further comprises the reflective plate, the reflective plate has the reflective surface, and the second radiating element and the second conductive part are located on one side of the reflective surface.

13. The antenna according to claim 12, wherein that the second conductive part and the first radiating element are connected to a common ground comprises: the second radiating element and the second conductive part are electrically connected to a common ground point on the reflective plate.

14. The antenna according to claim 1, wherein the antenna further comprises a third conductive part, and the third conductive part and the first radiating element are connected to a common ground; and
the third conductive part is located at the center of the first radiating element, and the third conductive part is coupled to the first radiating element, and is configured to suppress common-mode resonance generated by the first radiating element in the second radiating element.

15. The antenna according to claim 14, wherein the third conductive part is in a linear shape, or wherein the third conductive part is a metal strip or a printed circuit board.

16. The antenna according to claim 14, wherein the antenna further comprises a balun, and the third conductive part is electrically connected to the balun.

17. The antenna according to claim 14, wherein the antenna further comprises the reflective plate, the reflective plate has the reflective surface, and the first radiating element and the third conductive part are located on one side of the reflective surface.

18. The antenna according to claim 1, wherein the first conductive part is in a linear shape, or wherein the first conductive part is a metal strip or a printed circuit board.

19. The antenna according to claim 1, wherein the antenna further comprises a reflective plate, the reflective plate has a reflective surface, and the first radiating element and the first conductive part are located on one side of the reflective surface.

20. The antenna according to claim 19, wherein that the first conductive part and the first radiating element are connected to a common ground comprises: the first radiating element and the first conductive part are electrically connected to a common ground point on the reflective plate.
